(19) United States
(12) Patent Application Publication
(10) Pub. No.: US 2008/0267625 A1
(43) Pub. Date: Oct. 30, 2008

(54) Multi-Rate Multi-Wavelength Optical Burst Detector

(75) Inventor: Frank J. EFFENBERGER, Freehold, NJ (US)

Correspondence Address: CONLEY ROSE, P.C., 5601 GRANITE PARKWAY, SUITE 750, PLANO, TX, 75024, US

(73) Assignee: FUTUREWEI TECHNOLOGIES, INC., Plano, TX (US)

(21) Appl. No.: 12/027,387

(22) Filed: Feb. 7, 2008

Related U.S. Application Data
(60) Provisional application No. 60/915,038, filed on Apr. 30, 2007.

(51) Int. Cl. H04J 14/00

(52) U.S. Cl. 398/58

(57) ABSTRACT

An apparatus comprising an optical amplifier, an optical processor coupled to the optical amplifier, and a plurality of optical detectors coupled to the optical processor, wherein each optical detector is a single-rate detector. Also disclosed is an apparatus comprising at least one processor configured to implement a method comprising amplifying an optical signal comprising a plurality of rates, copying the amplified optical signal into a plurality of optical signals, and detecting a single rate on each of the copied optical signals. Included is a method comprising amplifying a first optical signal that is not compatible with a plurality of detectors, splitting the first optical signal into a plurality of second optical signals, and ignoring portions of the second optical signals to make the second optical signals compatible with the detectors.

### CROSS-REFERENCE TO RELATED APPLICATIONS

The present application claims priority to U.S. Provisional Patent Application Ser. No. 60/915,038 filed Apr. 30, 2007 by Frank J. Effenberger and entitled, “Multi-Rate Multi-Wavelength Optical Burst Detector,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A passive optical network (PON) is one system for providing network access over “the last mile.” The PON is a point to multi-point network comprised of an optical line terminal (OLT) at the central office, an optical distribution network (ODN), and a plurality of optical network terminals (ONTs) at the customer premises. In current PON systems, downstream data transmissions can be broadcasted to all of the ONTs, while upstream data transmissions can be transmitted to the OLT using time division multiple access (TDMA) techniques. For instance, Gigabit PON systems provide 2.5 Gigabits per second (Gbps) of downstream bandwidth and 1.25 Gbps of upstream bandwidth. Using TDMA techniques, the transmitted data can share a single upstream wavelength, for example 1310 nm, among several users.

Future PON systems are expected to support higher rates such as 10.3 Gbps, and/or more wavelengths. For example, wavelength division multiplexed (WDM) passive optical network (WPON) systems have been proposed to provide higher bandwidth per user and to support more users. In WPON systems, multiple wavelengths of light are used to carry multiple data signals. It is desirable that WPON and other PON systems be easily integrated with the current systems. The integration of the PON systems requires the use of OLT receivers that arc capable of detecting multi-rate, multi-wavelength signals.

### SUMMARY

In one embodiment, the disclosure includes an apparatus comprising an optical amplifier, an optical processor coupled to the optical amplifier, and a plurality of optical detectors coupled to the optical processor, wherein each optical detector is a single-rate detector.

In another embodiment, the disclosure includes an apparatus comprising at least one processor configured to implement a method comprising amplifying an optical signal comprising a plurality of rates, copying the amplified optical signal into a plurality of optical signals, and detecting a single rate on each of the copied optical signals.

In yet another embodiment, the disclosure includes a method comprising amplifying a first optical signal that is not compatible with a plurality of detectors, splitting the first optical signal into a plurality of second optical signals, and ignoring portions of the second optical signals to make the second optical signals compatible with the detectors.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a PON system.

FIG. 2 is a schematic diagram of an embodiment of a multi-rate, multi-wavelength detection system.

FIG. 3 is a schematic diagram of an embodiment of a multi-rate detection system.

FIG. 4 is a schematic diagram of another embodiment of a multi-rate, multi-wavelength detection system.

FIG. 5 is a flowchart of an embodiment of a multi-rate, multi-wavelength detection method.

FIG. 6 is a schematic diagram of one embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and apparatus for detecting a multi-rate, multi-wavelength signal in a PON. The multi-rate, multi-wavelength signal may comprise a plurality of data signals having different rates and different wavelengths. The system may detect the multi-rate, multi-wavelength signal by amplifying the multi-rate, multi-wavelength signal, splitting the amplified multi-rate, multi-wavelength signal into the plurality of single wavelength signals, and detecting a single rate from each of the single wavelength signals. The receivers used to detect the single wavelength signals may be single-rate receivers in that they can only detect data at a single-rate. The system may provide dynamic detection capabilities for integrated PON systems that transport multi-rate, multi-wavelength signals without utilizing opto-electronics based detectors with dynamic-rate functionality. The multi-rate, multi-wavelength detection system may also provide compatibility between different PON systems and facilitate integration between next generation PON systems and current PON systems.

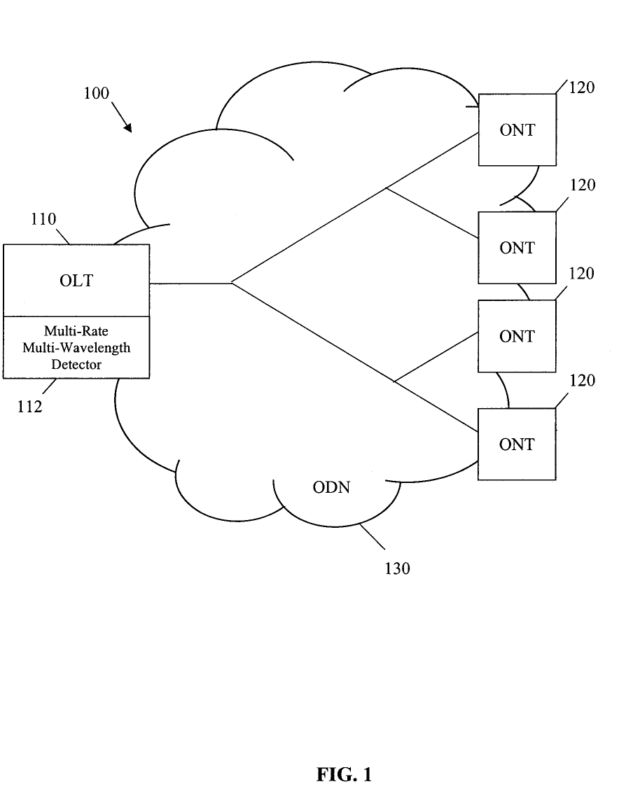

FIG. 1 illustrates one embodiment of a PON 100. The PON 100 comprises an OLT 110, a plurality of ONTs 120, and an ODN 130. The PON 100 is a communications network that does not require any active components to distribute data between the OLT 110 and the ONTs 120. Instead, the PON 100 uses the passive optical components in the ODN 130 to distribute data between the OLT 110 and the ONTs 120. Examples of suitable PONs 100 include the asynchronous transfer mode PON (APON) and the broadband PON (BPON) defined by the ITU-T G.983 standard, the Gigabit PON (GPON) defined by the ITU-T G.984 standard, the Ethernet PON (EPON) defined by the IEEE 802.3ah standard, and the wavelength division multiplexing PON (WPON), all of which are incorporated by reference as if reproduced in their entirety.

One component of the PON 100 may be the OLT 110. The OLT 110 may be any device that is configured to communicate with the ONTs 120 and another network (not shown). Specifically, the OLT 110 may act as an intermediary between the other network and the ONTs 120. For instance, the OLT 110 may forward data received from the network to the ONTs 120, and forward data received from the ONTs 120 onto the other network. Although the specific configuration of the OLT 110 may vary depending on the type of PON 100, in an embodiment, the OLT 110 may comprise a transmitter and a receiver, as explained in detail below. When the other network is using a protocol, such as Ethernet or SONET/SDH, that is different from the communications protocol used in the PON 100, the OLT 110 may comprise a converter that converts the other network's data into the PON's protocol. The OLT 110 converter may also convert the PON's data into the other network's protocol. The OLT 110 described herein is typically located at a central location, such as a central office, but may be located at other locations as well.

Another component of the PON 100 may be the ONTs 120. The ONTs 120 may be any devices that are configured to communicate with the OLT 110 and a customer or user (not shown). Specifically, the ONTs may act as an intermediary between the OLT 110 and the customer. For instance, the ONTs 120 may forward data received from the OLT 110 to the customer, and forward data received from the customer onto the OLT 110. Although the specific configuration of the ONTs 120 may vary depending on the type of PON 100, in an embodiment, the ONTs 120 may comprise an optical transmitter configured to send optical signals to the OLT 110. Additionally, the ONTs 120 may comprise an optical receiver configured to receive optical signals from the OLT 110 and a converter that converts the optical signal into electrical signals for the customer, such as signals in the ATM or Ethernet protocol. The ONTs 120 may also comprise a second transmitter and/or receiver that may send and/or receive the electrical signals to a customer device. In some embodiments, ONTs 120 and optical network units (ONUS) are similar, and thus the terms are used interchangeably herein. The ONTs are typically located at distributed locations, such as the customer premises, but may be located at other locations as well.

Another component of the PON 100 may be the ODN 130. The ODN 130 is a data distribution system that may comprise optical fiber cables, couplers, splitters, distributors, and/or other equipment. In an embodiment, the optical fiber cables, couplers, splitters, distributors, and/or other equipment are passive optical components. Specifically, the optical fiber cables, couplers, splitters, distributors, and/or other equipment may be components that do not require any power to distribute data signals between the OLT 110 and the ONTs 120. The ODN 130 typically extends from the OLT 110 to the ONTs 120 in a branching configuration as shown in FIG. 1, but may be alternatively configured as determined by a person of ordinary skill in the art.

The PON 100 described herein may comprise at least one multi-rate, multi-wavelength signal. The multi-rate, multi-wavelength signal may comprise a plurality of signals transmitted at different rates, different wavelengths, or combinations thereof. Specifically, the signals transmitted at different rates may be multiplexed into the multi-rate, multi-wavelength signal using time division multiplexing (TDM) or other multiplexing schemes. As such, the individual signals within the multi-rate, multi-wavelength signal may have substantially the same or overlapping wavelengths. If the multi-rate, multi-wavelength signal comprises a plurality of wavelengths, the signals transmitted at the different wavelengths or different ranges of wavelengths may comprise signals transmitted at similar rates. The signals transmitted at different wavelengths or different ranges of wavelengths may be multiplexed into a multi-rate, multi-wavelength signal using course wavelength division multiplexing (CWDM), dense wavelength division multiplexing (DWDM), or other WDM schemes.

The multi-rate, multi-wavelength signals may be created by a plurality of different types of PON components communicating with the same OLT. The signals may also be created by similar PON components having different communications protocols communicating with the same OLT. For instance, a first ONT may transmit a first upstream signal at a rate equal to about 1.25 Gbps and at a wavelength equal to about 1310 nanometer (nm). A second ONT communicating with the PON 100 may transmit a second upstream signal at a rate equal to about 10.3 Gbps and at a wavelength equal to about 1310 nm. The first and second upstream signals may be multiplexed using a TDM scheme into an upstream multi-rate signal. The multi-rate wavelength signal may hence comprise two rates (at about 1.25 Gbps and about 10.3 Gbps) and at one wavelength (at about 1310 nm). In another example, a third ONT may transmit a third upstream signal that may be a coarse WDM (CWDM) or a dense WDM (DWDM) signal. The third upstream signal may be transmitted at one of a plurality of wavelengths, including a wavelength equal to about 1310 nm, and at a rate equal to about 1.25 Gbps. The third upstream signal may then be multiplexed with the first upstream signal and the second upstream signal using both a TDM scheme and a WDM scheme into an upstream multi-rate, multi-wavelength signal. The multi-rate, multi-wavelength signal may hence comprise two rates (at about 1.25 Gbps and about 10.3 Gbps) and at a plurality of wavelengths.

As such, the PON 100 may comprise a multi-rate, multi-wavelength detector 112 configured to detect the multi-rate, multi-wavelength signal. The multi-rate, multi-wavelength signal may be received from OLT 110, the ONTs 120, or other networks that are in communication with the PON 100, or combinations thereof Specifically, the multi-rate, multi-wavelength detector 112 may amplify the multi-rate, multi-wavelength signal, separate the multi-rate, multi-wavelength signal into a plurality of signals, and detect each one of the signals separately. The multi-rate, multi-wavelength detector may further comprise a plurality of optical detectors that each detect one of the signals separately at a single-rate and a single-wavelength, as described in detail below. Although the multi-rate, multi-wavelength detector 112 is shown coupled to the OLT 110 in FIG. 1, in other embodiments the multi-rate, multi-wavelength detector 112 may be coupled to other PON components, including the ONTs 120.

The multi-rate, multi-wavelength detector 112 may separate the multi-rate, multi-wavelength signal into a plurality of individual signals that may be each detected separately using separate detectors. Specifically, the multi-rate, multi-wavelength detector 112 may separate the multi-rate, multi-wavelength signal to detect a first single-rate and single wavelength signal, a second single-rate and single-wavelength signal, and a plurality of third single-rate and single-wavelength signals. Continuing with the previous example, the first single-rate and single-wavelength signal may comprise the upstream signal transmitted from the first ONT at about 1.25 Gbps and about 1310 nm. The second single-rate and single-wavelength signal may comprise the signal transmitted from the second ONT at about 10.3 Gbps and about 1310 nm. The third single-rate and single-wavelength signal may comprise the signal transmitted from the third ONT at about 10.3 Gbps and one of the WDM wavelengths.

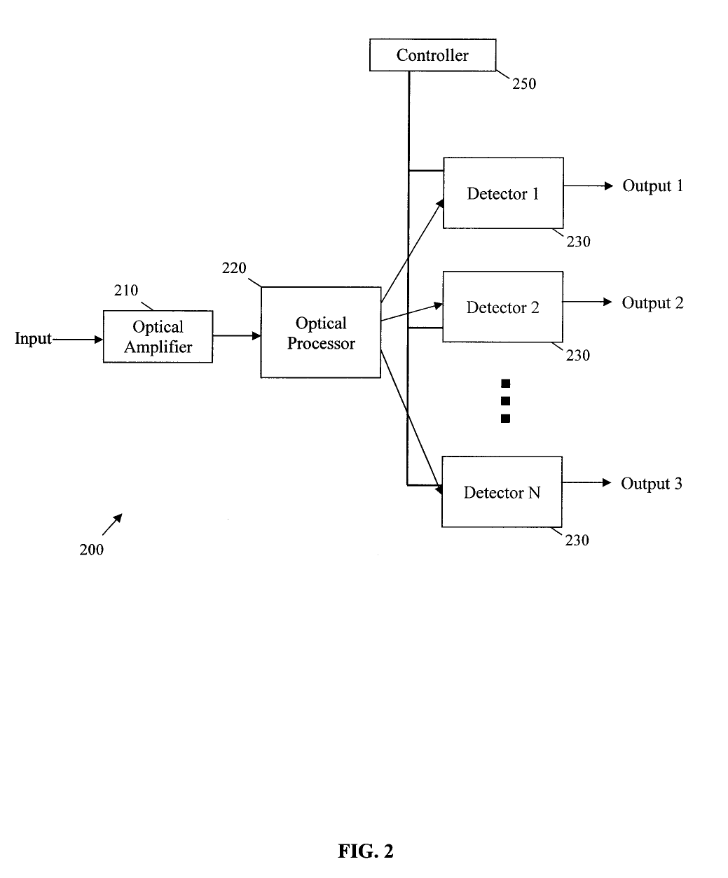

FIG. 2 illustrates one embodiment of a multi-rate, multi-wavelength detector 200. The multi-rate, multi-wavelength detector 200 may comprise an optical amplifier 210, an optical processor 220, a plurality of optical detectors 230, and a controller 250. Although three optical detectors are shown in FIG. 2, the apparatus 200 may comprise any number of optical detectors 230.

The optical amplifier 210 may be any optical device that may amplify the multi-rate, multi-wavelength signal. Specifically, the optical amplifier 210 may be coupled to the optical processor 220 and configured to increase the strength of the multi-rate, multi-wavelength signal. Such amplification may compensate for any signal losses introduced at the optical processor 220. The optical amplifier may be a laser amplifier comprising an active medium that can be pumped to produce gain for incoming light at a particular wavelength. The optical amplifier may also be a doped fiber amplifier comprising a doped optical fiber that can be pumped to produce gain. For example, the optical amplifier 210 may be an Erbium-doped fiber amplifier, which can amplify light at various wavelengths when pumped by an external light source. The optical amplifier 210 may also be a semiconductor optical amplifier that comprises a semiconductor gain medium that can be pumped, which may also include anti-reflection optical elements at both ends. In another embodiment, the optical amplifier 210 may be a Raman optical amplifier, wherein optical gain may be achieved by nonlinear interaction between the incoming optical signal and a pump laser within an optical fiber. The optical amplifier 210 may also comprise a combination of different types of optical amplifiers.

The optical processor 220 may be coupled to the optical amplifier 210 and to the plurality of optical detectors 230. The optical processor 220 may comprise one or a plurality of components that may be configured to split or copy the multi-rate, multi-wavelength signal into a plurality of single-wavelength signals. As such, the optical processor 220 may comprise one or more optical components, such as splitters, optical demultiplexers, filters, or other optical components. Specifically, optical filters or optical demultiplexers may be used to split the multi-wavelength signal into a plurality of single-wavelength signals. Similarly, the optical processor 220 may copy the multi-rate signal into a plurality of single-rate signals. Each of the single-rate signals or single-wavelength signals may comprise one portion of the amplified multi-rate signal strength minus any signal losses introduced at the optical processor 220. The power loss incurred in such splitting or copying may be compensated for by the prior optical amplification, such that the power of the signals exiting the optical processor 220 is substantially equal to the power of the multi-rate, multi-wavelength signal entering the optical amplifier 210.

Each optical detector 230 may receive one of the single-wavelength signals. Each optical detector 230 may be configured to only detect signals at a single-rate and at a single-wavelength, and may ignore any other rates and wavelengths in the signal. Each of the optical detectors may be configured to detect the single-rate signal, which is transmitted at a rate that may be different from at least one of the other single-rate signals.

The optical detectors may be coupled, in addition to the optical processor 220, to a controller 250 configured to implement a TDMA scheme. The controller 250 may use the TDMA scheme to inform the optical detectors 230 when to detect the single-rate signals. Specifically, the controller 250 may activate each of the optical detectors 230 at a designated time slot, and deactivate the optical detector during other timeslots. In some embodiments, the controller 250 may not be necessary when each of the optical detectors 230 may detect only one rate, one wavelength, or both and ignore the remaining rates and wavelengths in the signal.

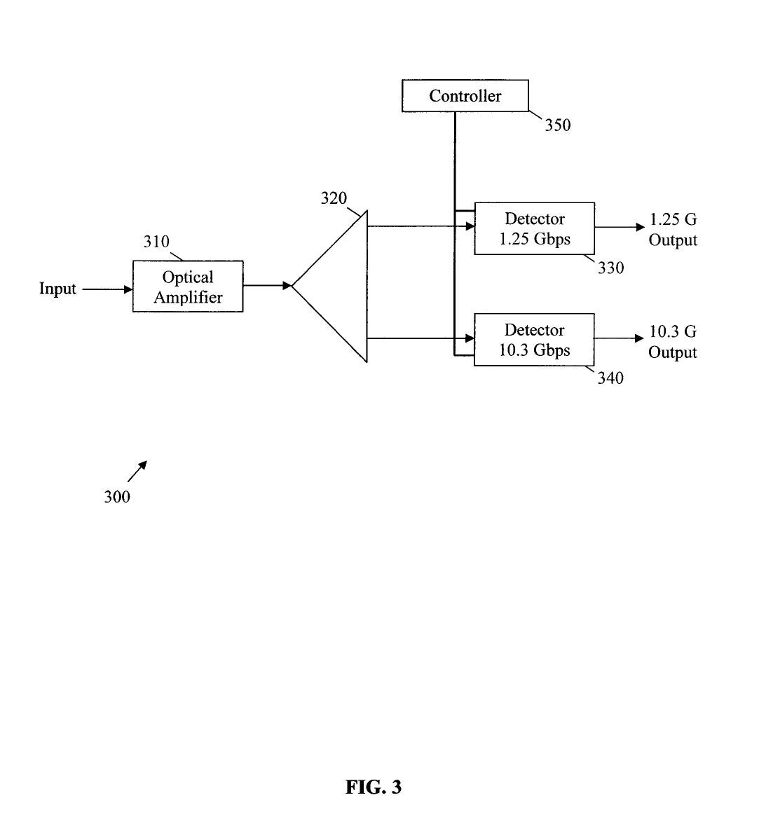

FIG. 3 illustrates another embodiment of a multi-rate, multi-wavelength detector 300. The multi-rate, multi-wavelength detector 300 may comprise an optical amplifier 310 coupled to an optical splitter 320. The optical splitter 320 may be coupled to two optical detectors, 330 and 340, which in turn are coupled to a controller 350. The multi-rate, multi-wavelength detector 300 may receive a multi-rate signal transmitted at a single wavelength, for example, at a wavelength equal to about 1310 nm. The multi-rate signal may comprise two TDM multiplexed signals transmitted at rates equal to about 1.25 Gbps and 10.3 Gbps. The optical amplifier 310 may amplify the multi-rate signal and the amplified multi-rate signal may be transported to the optical splitter 320, where the amplified multi-rate signal may be split or copied into two identical signals.

The two signals may be each transported to one of the two optical detectors 330 and 340. The optical detector 330 may be configured to detect a first signal rate, such as about 1.25 Gbps, and the optical detector 340 may be configured to detect a second signal rate, such as about 10.3 Gbps. As such, the optical detector 330 may detect a first part of the multi-rate, and the optical detector 340 may detect the second part of the multi-rate signal. In other embodiments, the multi-rate, multi-wavelength detector 300 may comprise more than two optical detectors coupled to the optical splitter 320, such that there is one detector for every rate in the multi-rate signal.

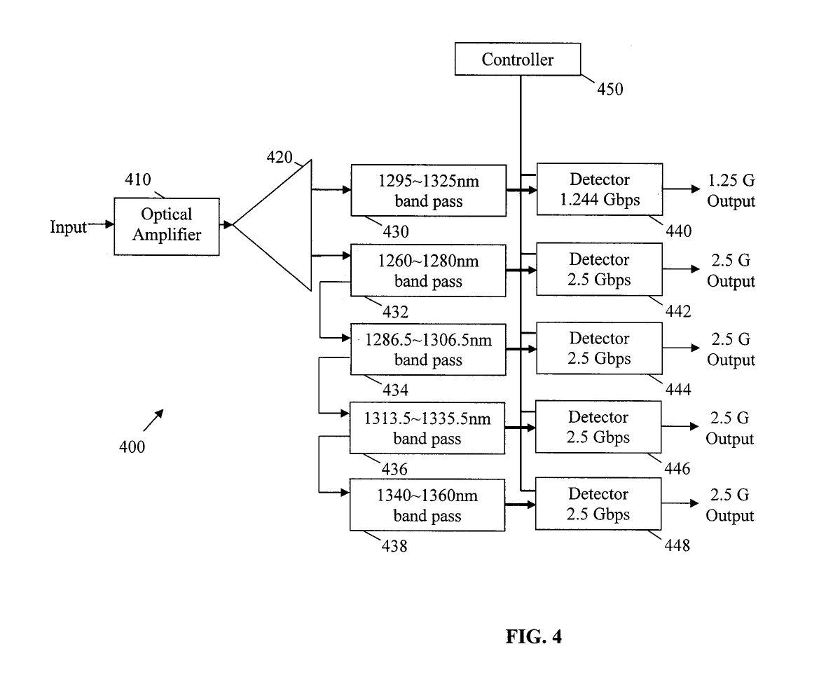

FIG. 4 illustrates another multi-rate, multi-wavelength detector 400. The multi-rate, multi-wavelength detector 400 may comprise an optical amplifier 410 coupled to an optical splitter 420. The optical splitter 420 may be coupled to five optical filters 430, 432, 434, 436, and 438. Specifically, the optical splitter 420 may be directly coupled to the optical filters 430, 432, and indirectly coupled to the optical filters 434, 436, and 438. The optical filters 430, 432, 434, 436, and 438 may be band pass filters that filter signals at different wavelength ranges. The band pass filters, 430, 432, 434, 436, and 438 may each be coupled to the optical detectors 440, 442, 444, 446, and 448, respectively. The multi-rate, multi-wavelength detector 400 may receive a multi-rate, multi-wavelength signal comprising a first wavelength channel transmitted at about 1.25 Gbps and centered at about 1310 nm, and four additional wavelength channels transmitted at about 2.5 Gbps and centered at about 1270 nm, about 1296.5 nm, about 1323.5 nm, and about 1350 nm.

The optical splitter 420 may split the amplified multi-rate, multi-wavelength signal into a first portion and a second portion. The first portion may be transported to the band pass filter 430 that may be configured to filter any signals that are not from about 1295 nm to about 1325 nm. The second portion may be transported to the band pass filter 432 that may be configured to filter any signals that are not from about 1260 nm to about 1280 nm.

The band pass filter 432 may send any remaining part of the second portion to the band pass filter 434, which may be configured to filter any signals that are not from about 1286.5 nm to about 1306.5 nm. The band pass filter 434 may send any remaining part of the second portion to the band pass filter 436, which may be configured to filter any signals that are not from about 1313.5 nm to about 1335.5 nm. The band pass filter 436 may send any remaining part of the second portion to the band pass filter 438, which may be configured to filter any signals that are not from about 1340 nm to about 1360 nm.

The band pass filters 430, 432, 434, 436, and 438 may send their signals to the optical detectors 440, 442, 444, 446, and 448, respectively. Specifically, the optical detector 440 may receive a signal that is transmitted at about 1.25 Gbps at about 1310 nm. Similarly, the optical detectors 442, 444, 446, and 448 may receive signals that are transmitted at about 2.5 Gbps at the center of the additional wavelength channels at about 1270 nm, about 1296.5 nm, about 1323.5 nm, and about 1350 nm, respectively. Thus, some of the wavelength channels that are received at the optical detectors 440, 442, 444, 446, and 448 may overlap. For instance, the first wavelength channel from about 1295 nm to about 1325 nm at optical detector 440 may overlap with the third wavelength channel from about 1286.5 nm to about 1306.5 nm at optical detector 444. The first wavelength channel at optical detector 440 may also overlap with the fourth wavelength channel from about 1313.5 nm to about 1335.5 nm at optical detector 446. As such, optical detector 440 may receive a portion of the signal corresponding to optical detectors 444, 446, and optical detectors 444 and 446 may receive a portion of the signal corresponding to optical detector 440. However, these redundant signals may be resolved by the controller 450, for example, using a TDMA scheme. Specifically, optical detector 440 may detect only the signal corresponding to about 1.25 Gbps transmission rate. Optical detectors 444 and 446 may each detect only the signal corresponding to about 2.5 Gbps transmission rate.

In another embodiment, the multi-rate, multi-wavelength detector may receive multi-wavelength signals at a single rate, for example, at a rate equal to about 2.5 Gbps. In such a case, the multi-rate, multi-wavelength detector may comprise an optical amplifier that may amplify the multi-wavelength signal, and an optical demultiplexer or a plurality of optical filters that may split the amplified multi-wavelength signal into a plurality of signals corresponding to the different wavelength channels. In such a case, the optical filters may be configured similarly to optical filters 432, 434, 436, and 438 in FIG. 4. The plurality of signals may then be each transmitted over the different wavelength channels to separate optical detectors.

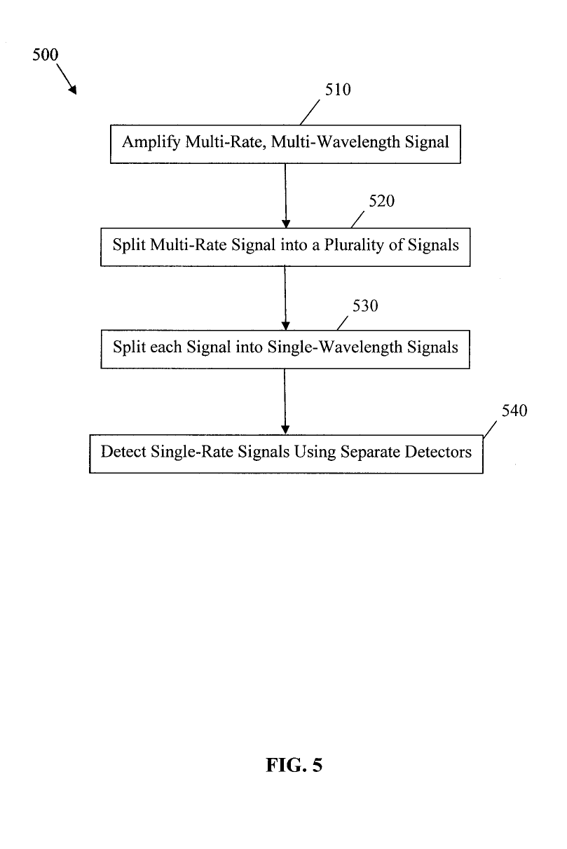

FIG. 5 illustrates an embodiment of a multi-rate, multi-wavelength signal detection method 500. The method 500 may be implemented at the OLT 110 or any other component of the PON 100. At block 510, the method 500 may amplify the incoming multi-rate, multi-wavelength signal. The multi-rate, multi-wavelength signal may be amplified by increasing the strength of the multi-rate, multi-wavelength signal. At block 520, the method 500 may split the multi-rate, multi-wavelength signal into a plurality of multi-rate, multi-wavelength signals. At block 530, the method 500 may split each of the split signals into a plurality of single-wavelength signals. At block 540, the method 500 may detect each of the single-rate signals separately using separate optical detectors. The method 500 may detect each of the signals corresponding to different wavelength channels or to overlapping wavelength channels using separate wavelength filters coupled to separate detectors. The method 500 may also configure each detector to detect a single-rate, single-wavelength signal with high sensitivity. In another embodiment, the method 500 may first split the multi-rate, multi-wavelength signal into a plurality of single-wavelength signals, each comprising a plurality of signals that are transmitted at different rates. The method 500 may then split each of the single-wavelength signals into a plurality of separate signals, which may be detected separately.

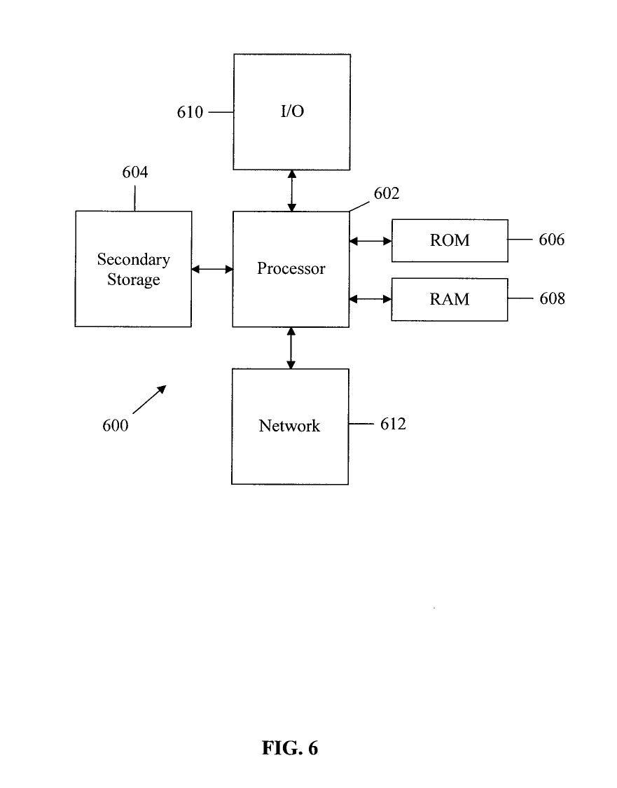

The network components described above may be implemented on any general-purpose network component, such as a computer or network component with sufficient processing power, memory resources, and network throughput capability to handle the necessary workload placed upon it. FIG. 6 illustrates a typical, general-purpose network component suitable for implementing one or more embodiments of a node disclosed herein. The network component 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor may be implemented as one or more CPU chips, or may be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage. The RAM 608 is used to store volatile data and perhaps to store instructions. Access to both ROM 606 and RAM 608 is typically faster than to secondary storage 604.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
an optical amplifier;
an optical processor coupled to the optical amplifier; and
a plurality of optical detectors coupled to the optical processor, wherein each optical detector is a single-rate detector.

2. The apparatus of claim 1, wherein the optical processor consists essentially of a splitter.

3. The apparatus of claim 1, wherein the optical processor comprises a plurality of wavelength filters each coupled to one of the optical detectors.

4. The apparatus of claim 3, wherein the optical processor further comprises a splitter coupled to the optical amplifier.

5. The apparatus of claim 4, wherein at least one wavelength filter is coupled to the splitter, and wherein any remaining wavelength filters are coupled to another wavelength filter.

6. The apparatus of claim 3, wherein the wavelength filters are band pass filters.

7. The apparatus of claim 1, wherein each of the optical detectors detects a unique combination of rate and frequency range.

8. The apparatus of claim 1, wherein the optical detectors are coupled in parallel to the optical processor.

9. The apparatus of claim 1, further comprising a time division multiple access (TDMA) controller coupled to at least some of the optical detectors.

10. An apparatus comprising:
at least one processor configured to implement a method comprising:
amplifying an optical signal comprising a plurality of rates;
copying the amplified optical signal into a plurality of optical signals; and
detecting a single rate on each of the copied optical signals.

11. The apparatus of claim 10, wherein the method further comprises time division demultiplexing each of the detected optical signals.

12. The apparatus of claim 10, wherein the optical signal further comprises a plurality of wavelengths.

13. The apparatus of claim 12, wherein the method further comprises separating the amplified optical signal or at least one of the copied optical signals into a plurality of single-wavelength optical signals.

14. The apparatus of claim 12, wherein a first detected optical signal operates at a first rate and at a first wavelength, a second detected optical signal operates at a second rate and at a second wavelength, a third detected optical signal operates at the second rate and at a third wavelength, a fourth detected optical signal operates at the second rate and at a fourth wavelength, and a fifth detected optical signal operates at the second rate and at a fifth wavelength.

15. The apparatus of claim 12, wherein the wavelengths for one of the rates overlap with the wavelengths for another one of the rates.

16. The apparatus of claim 15, wherein the first rate is equal to about 1.25 Gigabit per second (Gbps), the first wavelength is equal to about 1310 nanometers (nm), the second rate is equal to about 2.5 Gbps, the second wavelength is equal to about 1270 nm, the third wavelength is equal to about 1296.5 nm, the fourth wavelength is equal to about 1324.5 nm, and the fifth wavelength is equal to about 1350 nm.

17. A method comprising:
amplifying a first optical signal that is not compatible with a plurality of detectors;
splitting the first optical signal into a plurality of second optical signals; and
ignoring portions of the second optical signals to make the second optical signals compatible with the detectors.

18. The system of claim 17, wherein no multi-rate opto-electronic components are required to detect the second optical signals.

19. The method of claim 17, wherein the method further comprises amplifying the first optical signal.

20. The method of claim 17, wherein the remaining portion of each of the second optical signals represents a singe rate.
